(19) United States
(12) Patent Application Publication
(10) Pub. No.: US 2011/0156639 A1
(43) Pub. Date: Jun. 30, 2011

(54) Wireless Power Transmission Apparatus

(75) Inventors: Young Ho Ryu, Yongin-si (KR); Eun Seok Park, Suwon-si (KR); Sang Wook Kwon, Seongnam-si (KR); Young Tack Hong, Seongnam-si (KR); Nam Yun Kim, Seoul (KR)

(73) Assignee: Samsung Electronics Co., Ltd., Suwon-si (KR)

(21) Appl. No.: 12/977,424

(22) Filed: Dec. 23, 2010

(30) Foreign Application Priority Data
Dec. 30, 2009 (KR) 10-2009-0133594

(51) Int. Cl. H02J 7/00

(52) U.S. Cl. 320/108; 320/166

(57) ABSTRACT

A wireless power transmission apparatus is provided. The wireless power transmission device includes a source unit comprising a source resonator to transmit power wirelessly to at least one target device, and an energy charging module to store energy generated by the source unit under a control of the source unit.

### CROSS-REFERENCE TO RELATED APPLICATION(S)

This application claims the benefit under 35 U.S.C. §119(a) of Korean Patent Application No. 10-2009-0133594, filed on Dec. 30, 2009, in the Korean Intellectual Property Office, the entire disclosure of which is incorporated herein by reference for all purposes.

### BACKGROUND

1. Field

The following description relates to a wireless power transmission system, and more particularly, to a wireless power transmission apparatus having an energy charging module.

2. Description of Related Art

With the development of Information Technology (IT), a variety of portable electronic devices have also increased. Because of the characteristics of the portable electronic devices, battery performance of a corresponding portable electronic is an important issue. In addition to the portable electronic devices, home electronic appliances can be supplied with power over a power line.

Currently, researches are being conducted on a wireless power transmission technology that may wirelessly supply power to either a portable electronic device and/or a home electronic appliance. Due to characteristics of a wireless power transmission environment, peripheral apparatuses may be influenced by a magnetic field of a wireless power transmission apparatus, and energy that is stored in a near field may be lost instead of being transmitted during a wireless power transmission.

Accordingly, there is a desire for a wireless power transmission apparatus that may reduce the influence on peripheral apparatuses and minimize energy loss.

### SUMMARY

In one general aspect, there is provided a wireless power transmission apparatus, comprising a source unit comprising a source resonator for transmitting power wirelessly to at least one target device, and an energy charging module for storing energy generated by the source unit under a control of the source unit.

The energy charging module may charge power that is obtained by subtracting power consumed by the at least one target device from power input to the source unit.

The energy charging module may retransmit the stored energy to the source unit.

The energy charging module may provide the stored energy to a device connected to the energy charging module.

The energy charging module may comprise a charging resonator to receive power from the source resonator, and a large capacity capacitor to store the power received by the charging resonator.

In another aspect, there is provided an energy charging module for storing energy from a source unit that wirelessly transmits power to one or more target devices, the energy charging module comprising a charging resonator to receive power from the source unit, and a large capacity capacitor to store the power received by the charging resonator, wherein the energy charging module is controlled by the source unit.

The source unit may control the energy charging module to store power received by the source unit but not transmitted by the source unit to the one or more target devices.

The charging resonator may receive an amount of power from the source unit, and the amount of power may be equal to the amount of power input to the source unit minus the amount of power consumed by the one or more target devices.

The energy charging module may reuse the energy received from the source unit by transmitting the energy back to the source unit.

The energy charging module may reuse the energy received from the source unit by transmitting the energy to the one or more target devices.

The energy charging module may be included in the source unit.

The energy charging module may not be included in the source unit, and the energy charging module may receive power from the source unit through magnetic coupling.

Other features and aspects may be apparent from the following description, the drawings, and the claims.

### BRIEF DESCRIPTION OF THE DRAWINGS

to FIG. 1 is a diagram illustrating an example of a wireless power transmission system.

FIG. 2 is a diagram illustrating an example of a resonator having a two-dimensional (2D) structure.

FIG. 3 is a diagram illustrating an example of a resonator having a three-dimensional (3D) structure.

FIG. 4 is a diagram illustrating an example of a bulky-type resonator for wireless power transmission.

FIG. 5 is a diagram illustrating an example of a hollow-type resonator for wireless power transmission.

FIG. 6 is a diagram illustrating an example of a resonator for a wireless power transmission using a parallel-sheet.

FIG. 7 is a diagram illustrating an example of a resonator for wireless power transmission which includes a distributed capacitor.

FIGS. 8A and 8B are diagrams illustrating examples of matchers provided in the resonator of FIG. 2 and the resonator of FIG. 3, respectively.

FIG. 9 is a diagram illustrating an example of an equivalent circuit of a transmission line into which a capacitor of FIG. 2 is inserted.

FIG. 10 is a diagram illustrating an example of a wireless power transmission apparatus.

FIG. 11 is a diagram illustrating an example of an energy charging module of FIG. 10.

Throughout the drawings and the description, unless otherwise described, the same drawing reference numerals should be understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, description of well-known functions and constructions may be omitted for increased clarity and conciseness.

As described herein, for example, the transmitter may be, or may be included in, a terminal, such as a mobile terminal, a personal computer, a personal digital assistant (PDA), an MP3 player, and the like. As another example, the receiver described herein may be, or may be included in, a terminal, such as a mobile terminal, a personal computer, a personal digital assistant (PDA), an MP3 player, and the like. As another example, the transmitter and/or the receiver may be a separate individual unit.

FIG. 1 illustrates an example of a wireless power transmission system.

For example, wireless power transmitted using the wireless power transmission system may be referred to as resonance power.

Referring to FIG. 1, the wireless power transmission system includes a source-target structure including a source and a target. In this example, the wireless power transmission system includes a resonance power transmitter 110 corresponding to the source and a resonance power receiver 120 corresponding to the target.

The resonance power transmitter 110 includes a source unit 111 and a source resonator 115. The source unit 111 may receive energy from an external voltage supplier to generate resonance power. The resonance power transmitter 110 may further include a matching control 113 to perform resonance frequency or impedance matching.

For example, the source unit 111 may include an alternating current (AC)-to-AC (AC/AC) converter, an AC-to-direct current (DC) (AC/DC) converter, a DC-to-AC (DC/AC) inverter, and the like. The AC/AC converter may adjust a signal level of an AC signal input from an external device to a desired level. The AC/DC converter may output a DC voltage at a predetermined level by rectifying an AC signal output from the AC/AC converter. The DC/AC inverter may generate an AC signal in a band of hertz (Hz), for example, one or more megahertz (MHz), tens of MHz, and the like, by quickly switching a DC voltage output from the AC/DC converter.

For example, the matching control 113 may set at least one of a resonance bandwidth of the source resonator 115 and an impedance matching frequency of the source resonator 115. Although not illustrated, the matching control 113 may include, for example, at least one of a source resonance bandwidth setting unit and a source matching frequency setting unit. The source resonance bandwidth setting unit may set the resonance bandwidth of the source resonator 115. The source matching frequency setting unit may set the impedance matching frequency of the source resonator 115. In this example, a Q-factor of the source resonator 115 may be determined based on a setting of the resonance bandwidth of the source resonator 115 or a setting of the impedance matching frequency of the source resonator 115.

The source resonator 115 may transfer electromagnetic energy to a target resonator 121. For example, the source resonator 115 may transfer the resonance power to the resonance power receiver 120 through magnetic coupling 101 with the target resonator 121. The source resonator 115 may resonate within the set resonance bandwidth.

The resonance power receiver 120 includes the target resonator 121, a matching control 123 to perform resonance frequency or impedance matching, and a target unit 125 to transfer the received resonance power to a load.

The target resonator 121 may receive the electromagnetic energy from the source resonator 115. The target resonator 121 may resonate within the set resonance bandwidth.

The matching control 123 may set at least one of a resonance bandwidth of the target resonator 121 and an impedance matching frequency of the target resonator 121. Although not illustrated, the matching control 123 may include at least one of a target resonance bandwidth setting unit and a target matching frequency setting unit. The target resonance to bandwidth setting unit may set the resonance bandwidth of the target resonator 121. The target matching frequency setting unit may set the impedance matching frequency of the target resonator 121. In this example, a Q-factor of the target resonator 121 may be determined based on a setting of the resonance bandwidth of the target resonator 121 or a setting of the impedance matching frequency of the target resonator 121.

The target unit 125 may transfer the received resonance power to the load. For example, the target unit 125 may include an AC/DC converter and a DC/DC converter. The AC/DC converter may generate a DC voltage by rectifying an AC signal transmitted from the source resonator 115 to the target resonator 121. The DC/DC converter may supply a rated voltage to a device or the load by adjusting a voltage level of the DC voltage.

For example, the source resonator 115 and the target resonator 121 may be configured as a helix coil structured resonator, a spiral coil structured resonator, a meta-structured resonator, and the like.

Referring to FIG. 1, a process of controlling the Q-factor may include setting the resonance bandwidth of the source resonator 115 and the resonance bandwidth of the target resonator 121, and transferring the electromagnetic energy from the source resonator 115 to the target resonator 121 through magnetic coupling 101 that occurs between the source resonator 115 and the target resonator 121. The resonance bandwidth of the source resonator 115 may be set wider or narrower than the resonance bandwidth of the target resonator 121. For example, an unbalanced relationship between a BW-factor of the source resonator 115 and a BW-factor of the target resonator 121 may be maintained by setting the resonance bandwidth of the source resonator 115 to be wider or narrower than the resonance bandwidth of the target resonator 121.

In a wireless power transmission system that employs a resonance scheme, the resonance bandwidth may be an important factor. For example, when the Q-factor considering all of a change in a distance between the source resonator 115 and the target resonator 121, a change in the resonance impedance, impedance mismatching, a reflected signal, and the like, is Qt, Qt may have an inverse-proportional relationship with the resonance bandwidth, as given by Equation 1.

$$\begin{matrix}\frac{Δ f}{{f}_{0}} = \frac{1}{Qt} \\ = {Γ}_{S , D} + \frac{1}{{BW}_{S}} + \frac{1}{{BW}_{D}}\end{matrix} \qquad [ Equation 1 ]$$

In Equation 1, f₀ denotes a central frequency, Δf denotes a change in a bandwidth, Γ_{S, D} denotes a reflection loss between the source resonator 115 and the target resonator 121, BW_{S} denotes the resonance bandwidth of the source resonator 115, and BW_{D} denotes the resonance bandwidth of the target resonator 121. For example, the BW-factor may indicate either 1/BW_{S} or 1/BW_{D}.

For example, a change in the distance between the source resonator 115 and the target resonator 121, a change in a location of at least one of the source resonator 115 and the target resonator 121, and the like, may cause impedance mismatching between the source resonator 115 and the target resonator 121 to occur. As a result, the impedance mismatching may be a direct cause in decreasing an efficiency of power transfer. For example, when a portion of a transmission signal is reflected by a target instead of received by a target, this reflected wave may be detected. When a reflected wave is detected, the matching control 113 may determine the impedance mismatching has occurred, and may perform impedance matching. The matching control 113 may change a resonance frequency by detecting a resonance point through a waveform analysis of the reflected wave. For example, the matching control 113 may determine a frequency having a minimum amplitude in the waveform of the reflected wave, as the resonance frequency.

As described herein, a resonator may be configured as a helix coil structured resonator, a spiral coil structured resonator, a meta-structured resonator, and the like.

As described herein, various materials may have a unique magnetic permeability, for example, Mμ, and a unique permittivity, for example, epsilon ( ). The magnetic permeability indicates a ratio between a magnetic flux density that occurs with respect to a given magnetic field in a corresponding material and a magnetic flux density that occurs with respect to the given magnetic field in a vacuum state. For example, the magnetic permeability and the permittivity may determine a propagation constant of a corresponding material in a given frequency or at a given wavelength.

An electromagnetic characteristic of the corresponding material may be determined based on the magnetic permeability and the permittivity. For example, a material that has a magnetic permeability or a permittivity absent in nature and that is artificially designed is referred to as a metamaterial. The metamaterial may be disposed in a resonance state even in a relatively large wavelength area or a relatively low frequency area. For example, even though a material size rarely varies, the metamaterial may be easily disposed in the resonance state.

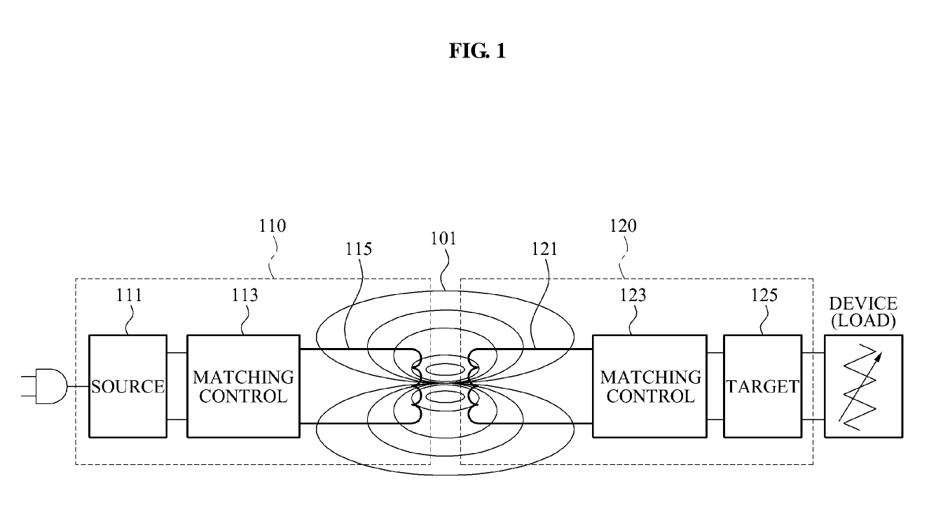

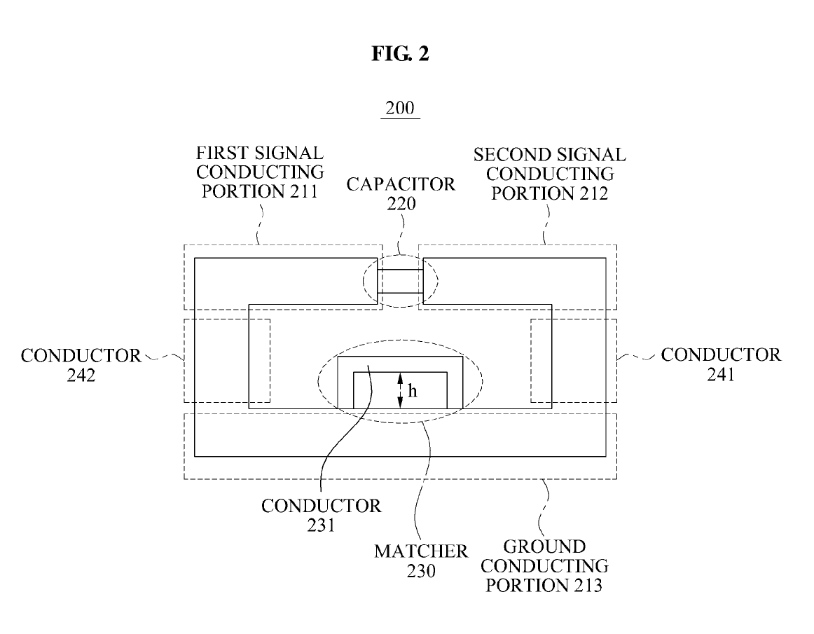

FIG. 2 illustrates an example of a resonator having a two-dimensional (2D) structure.

Referring to FIG. 2, resonator 200 that has the 2D structure includes a transmission line, a capacitor 220, a matcher 230, and conductors 241 and 242. In this example, the transmission line includes a first signal conducting portion 211, a second signal conducting portion 212, and a ground conducting portion 213.

For example, the capacitor 220 may be inserted in series between the first signal conducting portion 211 and the second signal conducting portion 212, and an electric field may be confined within the capacitor 220. Generally, the transmission line may include at to least one conductor in an upper portion of the transmission line, and may also include at least one conductor in a lower portion of the transmission line. A current may flow through the at least one conductor disposed in the upper portion of the transmission line. The at least one conductor disposed in the lower portion of the transmission may be electrically grounded. Herein, a conductor disposed in an upper portion of the transmission line is referred to as the first signal conducting portion 211 and the second signal conducting portion 212. A conductor disposed in the lower portion of the transmission line is referred to as the ground conducting portion 213.

As shown in FIG. 2, the resonator 200 has a 2D structure. The transmission line may include the first signal conducting portion 211 and the second signal conducting portion 212 in the upper portion of the transmission line, and may include the ground conducting portion 213 in the lower portion of the transmission line. The first signal conducting portion 211 and the second signal conducting portion 212 may be disposed such that they face the ground conducting portion 213. The current may flow through the first signal conducting portion 211 and the second signal conducting portion 212.

One end of the first signal conducting portion 211 may be shorted to the conductor 242, and another end of the first signal conducting portion 211 may be connected to the capacitor 220. One end of the second signal conducting portion 212 may be grounded to the conductor 241, and another end of the second signal conducting portion 212 may be connected to the capacitor 220. Accordingly, the first signal conducting portion 211, the second signal conducting portion 212, the ground conducting portion 213, and the conductors 241 and 242 may be connected to each other such that the resonator 200 has an electrically closed-loop structure. For example, the phrase “loop structure” may include a polygonal structure such as a circular structure, a rectangular structure, and the like. “Having a loop structure” may be used to indicate that a circuit is electrically closed.

The capacitor 220 may be inserted into an intermediate portion of the transmission line. For example, the capacitor 220 may be inserted into a space between the first signal conducting portion 211 and the second signal conducting portion 212. As an example, the capacitor 220 may have a shape of a lumped element, a distributed element, and the like. A distributed capacitor having the shape of the distributed element may include zigzagged conductor lines and a dielectric material between the zigzagged conductor lines. For example, the dielectric material may have a high permittivity.

When the capacitor 220 is inserted into the transmission line, the resonator 200 may have a property of a metamaterial. The metamaterial refers to a material that has a predetermined electrical property that has not been discovered in nature, and thus, may have an artificially designed structure. An electromagnetic characteristic of materials existing in nature may have a unique magnetic permeability or a unique permittivity. Most materials may have a positive magnetic permeability or a positive permittivity. In the case of most materials, a right hand rule may be applied to an electric field, a magnetic field, and a pointing vector, and thus, the corresponding materials may be referred to as right handed materials (RHMs). However, metamaterial has a magnetic permeability or a permittivity absent in nature, and thus, may be classified into an epsilon ( ) negative (ENG) material, a Mμ negative (MNG) material, a double negative (DNG) material, a negative refractive index (NRI) material, a left-handed (LH) material, and the like, based on a sign of the corresponding permittivity or magnetic permeability.

When a capacitance of the capacitor 220 inserted as the lumped element is determined, the resonator 200 may have metamaterial characteristics. Because the resonator 200 may have a negative magnetic permeability by adjusting the capacitance of the capacitor 220, the resonator 200 may also be referred to as an MNG resonator. For example, various criteria may be applied to determine the capacitance of the capacitor 220. For example, the various criteria may include a criterion for enabling the resonator 200 to have the metamaterial characteristic, a criterion for enabling the resonator 200 to have a negative magnetic permeability in a target frequency, a criterion for enabling the resonator 200 to have a zeroth order resonance characteristic in the target frequency, and the like. Based on one or more criterion, the capacitance of the capacitor 220 may be determined.

The resonator 200, also referred to as the MNG resonator 200, may have a zeroth order resonance characteristic of having, as a resonance frequency, a frequency when a propagation constant is “0”. For example, a zeroth order resonance characteristic may be a frequency transmitted through a line or a medium that has a propagation constant of “0”. Because the resonator 200 may have the zeroth order resonance characteristic, the resonance frequency may be independent with respect to a physical size of the MNG resonator 200. By appropriately designing the capacitor 220, the MNG resonator 200 may sufficiently change the resonance frequency. Accordingly, the physical size of the MNG resonator 200 may not be changed.

In a near field, for example, the electric field may be concentrated on the capacitor 220 inserted into the transmission line. Accordingly, due to the capacitor 220, the magnetic field may become dominant in the near field. The MNG resonator 200 may have a relatively high Q-factor using the capacitor 220 of the lumped element, and thus, it is possible to enhance an efficiency of power transmission. In this example, the Q-factor indicates a level of an ohmic loss or a ratio of a reactance with respect to a resistance in the wireless power transmission. The efficiency of the wireless power transmission may increase based on an increase in the Q-factor.

The MNG resonator 200 may include the matcher 230 for impedance matching. The matcher 230 may adjust a strength of a magnetic field of the MNG resonator 200. An impedance of the MNG resonator 200 may be determined by the matcher 230. A current may flow into and/or out of the MNG resonator 200 via a connector. For example, the connector may be connected to the ground conducting portion 213 or the matcher 230. The power may be transferred through coupling instead of using a physical connection between to the connector and the ground conducting portion 213 or the matcher 230.

For example, as shown in FIG. 2, the matcher 230 may be positioned within the loop formed by the loop structure of the resonator 200. The matcher 230 may adjust the impedance of the resonator 200 by changing the physical shape of the matcher 230. For example, the matcher 230 may include the conductor 231 for impedance matching in a location that is separated from the ground conducting portion 213 by a distance h. Accordingly, the impedance of the resonator 200 may be changed by adjusting the distance h.

Although not illustrated in FIG. 2, a controller may be provided to control the matcher 230. For example, the matcher 230 may change the physical shape of the matcher 230 based on a control signal generated by the controller. For example, the distance h between the conductor 231 of the matcher 230 and the ground conducting portion 213 may increase or decrease based on the control signal. Accordingly, the physical shape of the matcher 230 may be changed whereby the impedance of the resonator 200 may be adjusted. The controller may generate the control signal based on various factors. These factors are described later.

As shown in FIG. 2, the matcher 230 may be configured as a passive element such as the conductor 231. As another example, the matcher 230 may be configured as an active element such as a diode, a transistor, and the like. When the active element is included in the matcher 230, the active element may be driven based on the control signal generated by the controller, and the impedance of the resonator 200 may be adjusted based on the control signal. For example, a diode that is a type of the active element may be included in the matcher 230. Accordingly, the impedance of the resonator 200 may be adjusted based on whether the diode is in an ON state or in an OFF state.

Although not illustrated in FIG. 2, a magnetic core may pass through the MNG resonator 200. The magnetic core may perform a function of increasing a power transmission distance.

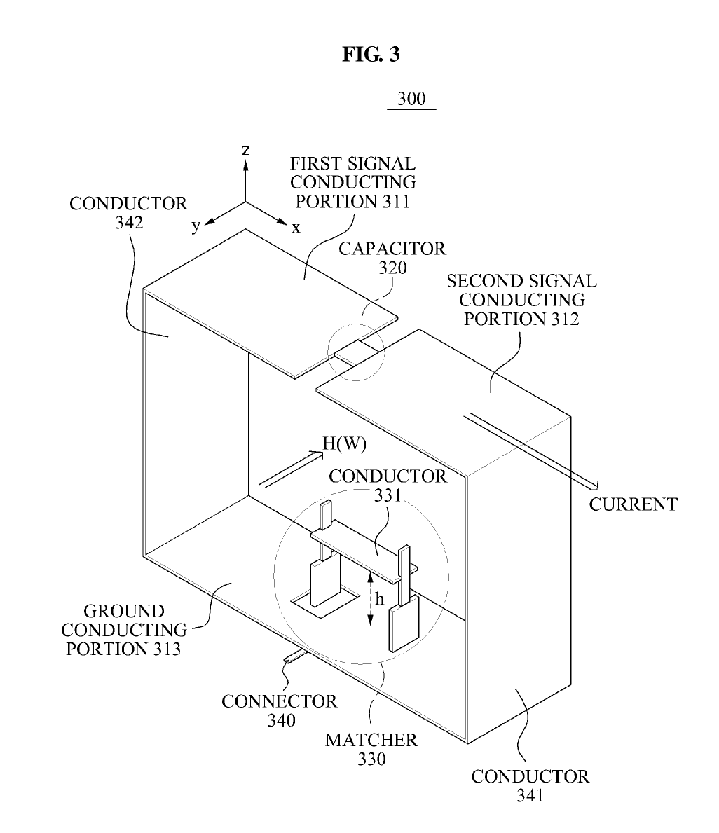

FIG. 3 illustrates an example of a resonator having a three-dimensional (3D) structure.

Referring to FIG. 3, resonator 300 that has the 3D structure includes a transmission line and a capacitor 320. In this example, the transmission line includes a first signal conducting portion 311, a second signal conducting portion 312, and a ground conducting portion 313. The capacitor 320 may be inserted in series between the first signal conducting portion 311 and the second signal conducting portion 312 of the transmission link, and an electric field may be confined within the capacitor 320.

As shown in FIG. 3, the resonator 300 may have the 3D structure. The transmission line includes the first signal conducting portion 311 and the second signal conducting portion 312 in an upper portion of the resonator 300, and includes a ground conducting portion 313 in a lower portion of the resonator 300. The first signal conducting portion 311 and the second signal conducting portion 312 may be disposed to face the ground conducting portion 313. A current may flow in an x direction through the first signal conducting portion 311 and the second signal conducting portion 312. Because of the current, a magnetic field H(W) may be formed in a −y direction. Alternatively, unlike the diagram of FIG. 3, the magnetic field H(W) may be formed in a +y direction.

One end of the first signal conducting portion 311 may be shorted to a conductor 342, and another end of the first signal conducting portion 311 may be connected to the capacitor 320. One end of the second signal conducting portion 312 may be grounded to a conductor 341, and another end of the second signal conducting portion 312 may be connected to the capacitor 320. Accordingly, the first signal conducting portion 311, the second signal conducting portion 312, the ground conducting portion 313, and the conductors 341 and 342 may be connected to each other such that the resonator 300 has an electrically closed-loop structure.

As shown in FIG. 3, the capacitor 320 may be inserted between the first signal conducting portion 311 and the second signal conducting portion 312. The capacitor 320 may be inserted into a space between the first signal conducting portion 311 and the second signal conducting portion 312. For example, the capacitor 320 may have a shape of a lumped element, a distributed element, and the like. For example, a distributed capacitor that has the shape of the distributed element may include zigzagged conductor lines and a dielectric material between the zigzagged conductor lines which has a relatively high permittivity.

As the capacitor 320 is inserted into the transmission line, the resonator 300 may have a property of a metamaterial.

For example, when a capacitance of the capacitor 320 inserted as the lumped element is determined, the resonator 300 may have the characteristic of the metamaterial. Because the resonator 300 may have a negative magnetic permeability by adjusting the capacitance of the capacitor 320, the resonator 300 may also be referred to as an MNG resonator. Various criteria may be applied to determine the capacitance of the capacitor 320. For example, the various criteria may include a criterion for enabling the resonator 300 to have the characteristic of the metamaterial, a criterion for enabling the resonator 300 to have a negative magnetic permeability in a target frequency, a criterion enabling the resonator 300 to have a zeroth order resonance characteristic in the target frequency, and the like. The capacitance of the capacitor 320 may be determined based on one or more criterion.

The resonator 300, also referred to as the MNG resonator 300, may have a zeroth order resonance characteristic. Because the resonator 300 may have the zeroth order resonance characteristic, the resonance frequency may be independent with respect to a physical size of the MNG resonator 300. By designing the capacitor 320, the MNG resonator 300 may sufficiently change the resonance frequency. Accordingly, the physical size of the MNG resonator 300 may not be changed.

Referring to the MNG resonator 300 of FIG. 3, for example, in a near field, the electric field may be concentrated on the capacitor 320 inserted into the transmission line. Accordingly, due to the capacitor 320, the magnetic field may become dominant in the near field. For example, because the MNG resonator 300 having the zeroth-order resonance characteristic may have characteristics similar to a magnetic dipole, the magnetic field may become dominant in the near field. A relatively small amount of the electric field formed due to the insertion of the capacitor 320 may be concentrated on the capacitor 320, and thus, the magnetic field may become further dominant.

The MNG resonator 300 may include a matcher 330 for impedance matching. The matcher 330 may adjust the strength of magnetic field of the MNG resonator 300. An impedance of the MNG resonator 300 may be determined by the matcher 330. A current may flow into and/or out of the MNG resonator 300 via a connector 340. The connector 340 may be connected to the ground conducting portion 313 or the matcher 330.

For example, as shown in FIG. 3, the matcher 330 may be positioned within the loop formed by the loop structure of the resonator 300. The matcher 330 may adjust the impedance of the resonator 300 by changing the physical shape of the matcher 330. For example, the matcher 330 may include a conductor 331 for the impedance matching in a location that is separated from the ground conducting portion 313 by a distance h. The impedance of the resonator 300 may be changed by adjusting the distance h.

Although not illustrated in FIG. 3, a controller may be provided to control the matcher 330. For example, the matcher 330 may change the physical shape of the matcher 330 based on a control signal generated by the controller. For example, the distance h between the conductor 331 of the matcher 330 and the ground conducting portion 313 may increase or decrease based on the control signal. Accordingly, the physical shape of the matcher 330 may be changed whereby the impedance of the resonator 300 may be adjusted.

For example, the distance h between the conductor 331 of the matcher 330 and the ground conducting portion 313 may be adjusted using a variety of schemes. As one example, a plurality of conductors may be included in the matcher 330 and the distance h may be adjusted by adaptively activating one of the conductors. As another example, the distance h may be adjusted by adjusting the physical location of the conductor 331 by moving the conductor 331 up and down. The distance h may be controlled based on the control signal of the controller. The controller may generate the control signal using various factors. An example of the controller generating the control signal is described later.

As shown in FIG. 3, the matcher 330 may be configured as a passive element such as the conductor 331. As another example, the matcher 330 may be configured as an active element such as a diode, a transistor, and the like. When the active element is included in the matcher 330, the active element may be driven based on the control signal generated by the controller, and the impedance of the resonator 300 may be adjusted based on the control signal. For example, a diode that is a type of the active element may be included in the matcher 330. The impedance of the resonator 300 may be adjusted based on whether the diode is in an ON state or in an OFF state.

Although not illustrated in FIG. 3, a magnetic core may pass through the resonator 300 configured as the MNG resonator. The magnetic core may perform a function of increasing a power transmission distance.

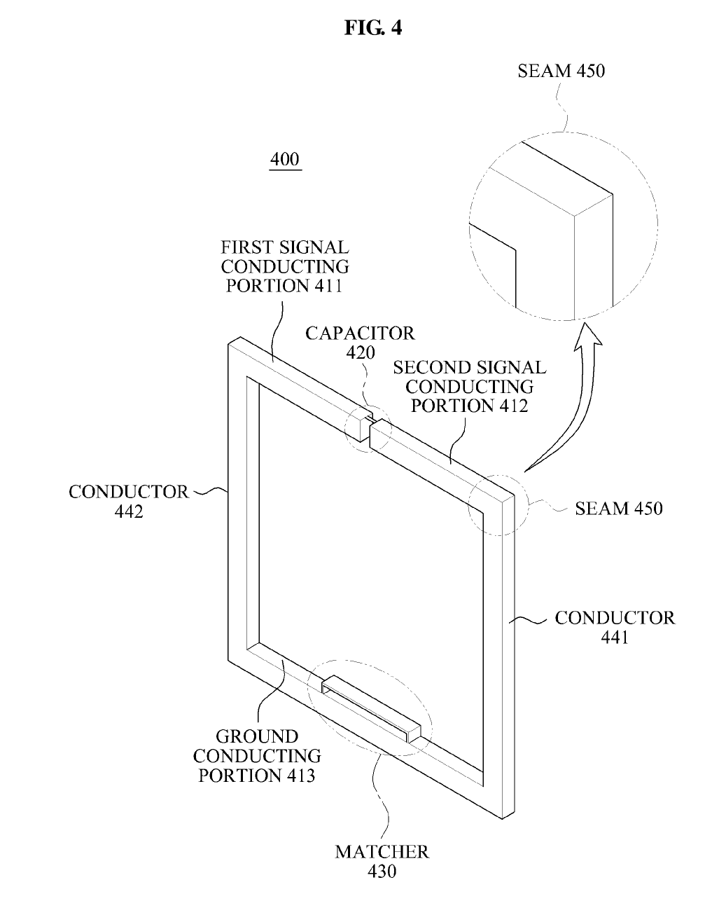

FIG. 4 illustrates an example of a bulky-type resonator for wireless power transmission.

Referring to FIG. 4, resonator 400 includes a first signal conducting portion 411 and a second signal conducting portion 412 that are integrally formed instead of being separately manufactured and subsequently connected to each other. The first signal conducting portion 411 and a conductor 442 may be integrally formed. The second signal conducting portion 412 and a conductor 441 may also be integrally formed.

When portions of the resonator are manufactured separately, and later formed together, a seam may occur between the portions. For example, when the second signal conducting portion 412 and the conductor 441 are separately manufactured and then are connected to each other, a loss of conduction may occur due to a seam 450. Accordingly, the second signal conducting portion 412, the conductor 441 may be connected to each other without using a separate seam such that they are seamlessly connected to each other. Accordingly, it is possible to decrease a conductor loss caused by the seam 450. As another example, the second signal conducting portion 412 and a ground conducting portion 413 may be seamlessly and integrally manufactured. As another example, the first signal conducting portion 411 and the ground conducting portion 413 may be seamlessly and integrally manufactured. As described with reference to FIG. 4, any of the components of the resonator may be seamlessly manufactured with other adjacent components of the resonator.

Referring to FIG. 4, a type of a seamless connection connecting at least two partitions into an integrated form may be referred to as a bulky type.

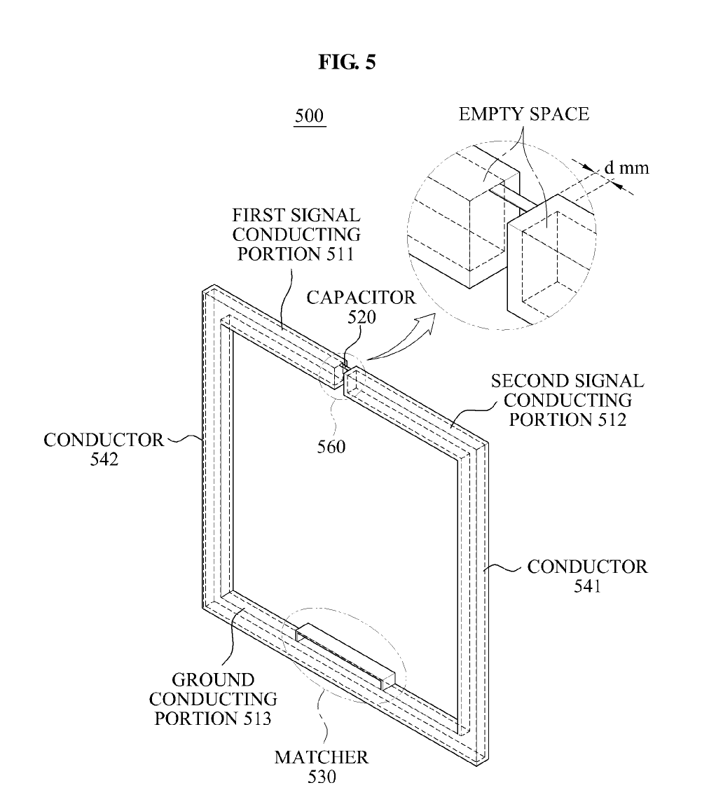

FIG. 5 illustrates an example of a hollow-type resonator for wireless power transmission.

Referring to FIG. 5, each of a first signal conducting portion 511, a second signal conducting portion 512, a ground conducting portion 513, and conductors 541 and 542 of resonator 500 are configured as a hollow-type and include an empty or hollow space inside.

In a given resonance frequency, an active current may be modeled to flow in only a portion of the first signal conducting portion 511 instead of all of the entire first signal conducting portion 511, only a portion of the second signal conducting portion 512 instead of the entire second signal conducting portion 512, only a portion of the ground conducting portion 513 instead of the entire ground conducting portion 513, and only a portion of the conductors 541 and 542 instead of the entire conductors 541 and 542. For example, when a depth of each of the first signal conducting portion 511, the second signal conducting portion 512, the ground conducting portion 513, and the conductors 541 and 542 is significantly deeper than a corresponding skin depth in the given resonance frequency, using only portion of the components of the resonator may be ineffective. The significantly deeper depth may increase a weight or manufacturing costs of the resonator 500.

Accordingly, in the given resonance frequency, the depth of each of the first signal conducting portion 511, the second signal conducting portion 512, the ground conducting portion 513, and the conductors 541 and 542 may be determined based on the corresponding skin depth of each of the first signal conducting portion 511, the second signal conducting portion 512, the ground conducting portion 513, and the conductors 541 and 542. When each of the first signal conducting portion 511, the second signal conducting portion 512, the ground conducting portion 513, and the conductors 541 and 542 have a depth deeper than a corresponding skin depth, the resonator 500 may become light, and manufacturing costs of the resonator 500 may also decrease.

For example, as shown in FIG. 5, the depth of the second signal conducting portion 512 may be determined as “d” mm and d may be determined according to

$$d = \frac{1}{\sqrt{π f μ σ}} .$$

In this example, f denotes a frequency, μ denotes a magnetic permeability, and σ denotes a conductor constant. As an example, when the first signal conducting portion 511, the second signal conducting portion 512, the ground conducting portion 513, and the conductors 541 and 542 are made of a copper and have a conductivity of 5.8×10⁷ siemens per meter (S·m⁻¹), the skin depth may be about 0.6 mm with respect to 10 kHz of the resonance frequency and the skin depth may be about 0.006 mm with respect to 100 MHz of the resonance frequency.

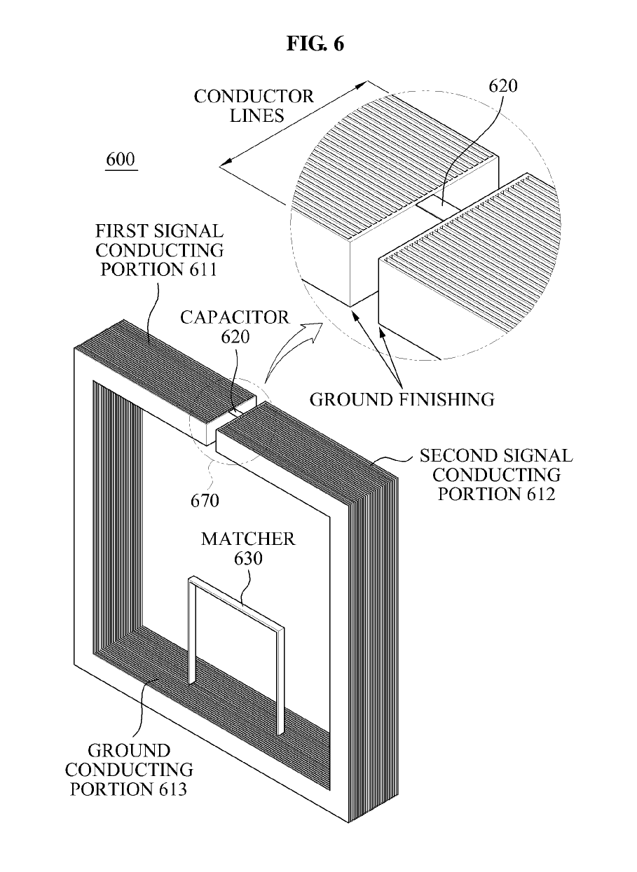

FIG. 6 illustrates an example of a resonator for wireless power transmission using a parallel-sheet.

Referring to FIG. 6, the parallel-sheet may be applicable to each of a first signal conducting portion 611 and a second signal conducting portion 612 included in the resonator 600.

Each of the first signal conducting portion 611 and the second signal conducting portion 612 may not be a perfect conductor and thus, may have some resistance. Because of this resistance, an ohmic loss may occur. The ohmic loss may decrease a Q-factor and also decrease a coupling effect.

By applying the parallel-sheet to each of the first signal conducting portion 611 and the second signal conducting portion 612, a decrease in ohmic loss may occur, and an increase in the Q-factor and the coupling effect may occur. Referring to a portion 670 indicated by a circle, when the parallel-sheet is applied, each of the first signal conducting portion 611 and the second signal conducting portion 612 may include a plurality of conductor lines. The plurality of conductor lines may be disposed in parallel, and may be shorted at an end portion of each of the first signal conducting portion 611 and the second signal conducting portion 612, respectively.

As described above, when the parallel-sheet is applied to each of the first signal conducting portion 611 and the second signal conducting portion 612, the plurality of conductor lines may be disposed in parallel or approximately parallel. Accordingly, a sum of resistances of the conductor lines may decrease. Consequently, the resistance loss may decrease, and the Q-factor and the coupling effect may increase.

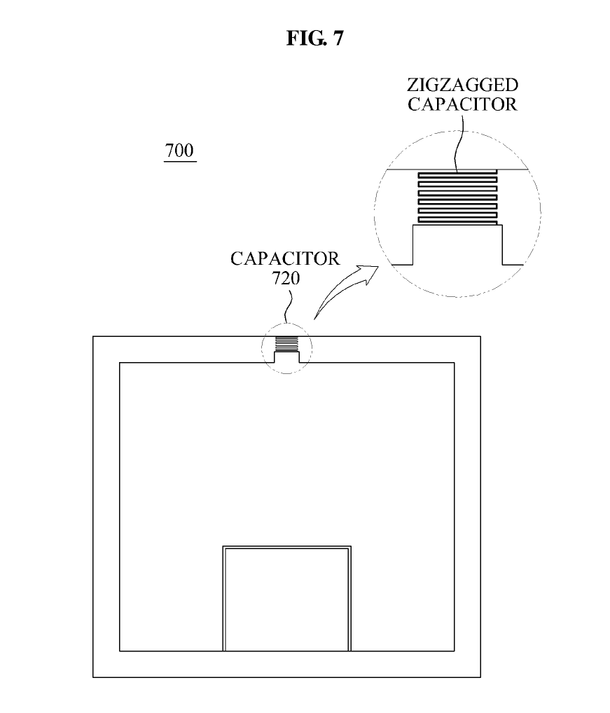

FIG. 7 illustrates an example of a resonator for wireless power transmission which includes a distributed capacitor.

Referring to FIG. 7, a capacitor 720 included in resonator 700 for the wireless power transmission may be a distributed capacitor. For example, a capacitor as a lumped element may have a relatively high equivalent series resistance (ESR). As described herein, by using the capacitor 720 as a distributed element, it is possible to decrease the ESR. A loss caused by the ESR may decrease a Q-factor and a coupling effect.

As shown in FIG. 7, the capacitor 720 as the distributed element may have a zigzagged structure. For example, the capacitor 720 may be configured as a conductive line and a conductor having the zigzagged structure.

As shown in FIG. 7, by employing the capacitor 720 as the distributed element, it is possible to decrease the loss caused by the ESR. In addition, by disposing a plurality of capacitors as lumped elements, it is possible to decrease the loss caused by the ESR. Because a resistance of each of the capacitors as the lumped elements decreases through a parallel connection, active resistances of parallel-connected capacitors as the lumped elements may also decrease and the loss caused by the ESR may decrease. For example, by employing ten capacitors of 1 pF instead of using a single capacitor of 10 pF, it is possible to decrease the loss caused by the ESR.

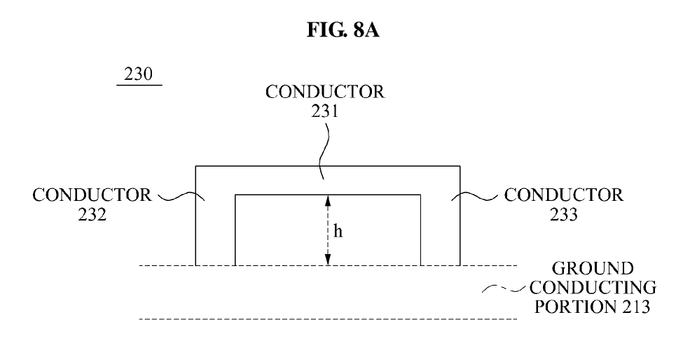

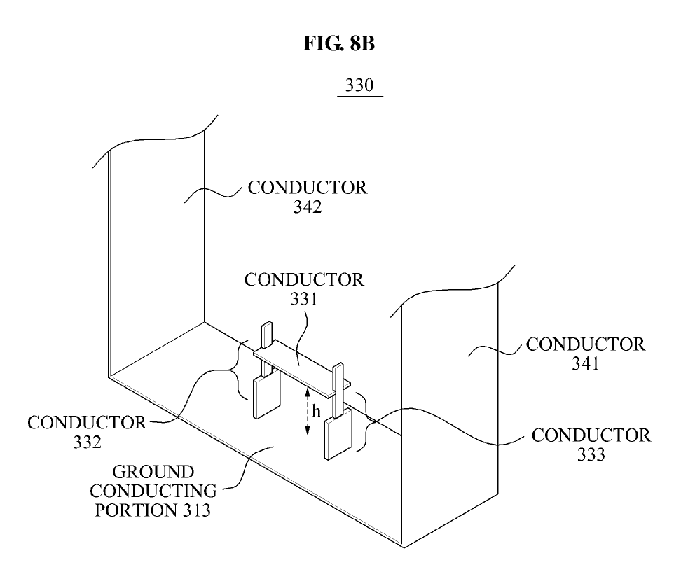

FIG. 8A illustrates an example of the matcher used in the resonator provided in the 2D structure of FIG. 2, and FIG. 8B illustrates an example of the matcher used in the resonator provided in the 3D structure of FIG. 3.

For example, FIG. 8A illustrates a portion of the 2D resonator that may be included in the matcher 230 of FIG. 2, and FIG. 8B illustrates a portion of the 3D resonator that may be included in the matcher 330 of FIG. 3.

Referring to FIG. 8A, the matcher 230 includes a conductor 231, a conductor 232, and a conductor 233. The conductors 232 and 233 may be connected to a ground conducting portion 213 and the conductor 231. For example, the impedance of the 2D resonator may be determined based on a distance h between the conductor 231 and the ground conducting portion 213. The distance h between the conductor 231 and the ground conducting portion 213 may be controlled by the controller. The distance h between the conductor 231 and the ground conducting portion 213 may be adjusted using a variety of schemes. For example, the variety of schemes may include a scheme for adjusting the distance h by adaptively activating one of the conductors 231, 232, and 233, a scheme of adjusting the physical location of the conductor 231 up and down, and the like.

Referring to FIG. 8B, the matcher 330 includes a conductor 331, a conductor 332, and a conductor 333, as well as conductors 341 and 342. The conductors 332 and 333 may be connected to a ground conducting portion 313 and the conductor 331. The conductors 332 and 333 may be connected to the ground conducting portion 313 and the conductor 331. For example, the impedance of the 3D resonator may be determined based on a distance h between the conductor 331 and the ground conducting portion 313. The distance h between the conductor 331 and the ground conducting portion 313 may be controlled by the controller. Similar to the matcher 230 included in the 2D structured resonator, in the matcher 330 included in the 3D structured resonator, the distance h between the conductor 331 and the ground conducting portion 313 may be adjusted using a variety of schemes. For example, the variety of schemes may include a scheme for adjusting the distance h by adaptively activating one of the conductors 331, 332, and 333, a scheme of adjusting the physical location of the conductor 331 up and down, and the like.

Although not illustrated in FIGS. 8A and 8B, the matcher may include an active element. A scheme of adjusting an impedance of a resonator using the active element may be similar as described above. For example, the impedance of the resonator may be adjusted by changing a path of a current flowing through the matcher using the active element.

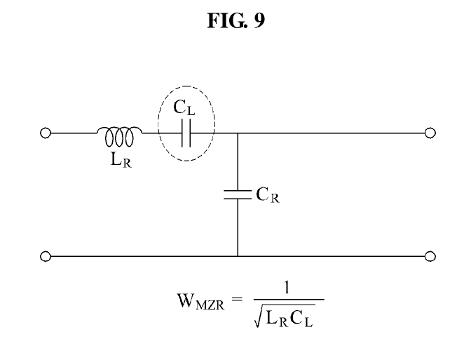

FIG. 9 illustrates an example of an equivalent circuit of the resonator for the wireless power transmission shown in FIG. 2.

Resonator 200 for the wireless power transmission shown in FIG. 2 may be modeled as the equivalent circuit of FIG. 9. In the equivalent circuit of FIG. 9, C_{L} denotes a capacitor that is inserted in a form of a lumped element in the middle of the transmission line of FIG. 2.

For example, the resonator 200 may have a zeroth resonance characteristic. For example, when a propagation constant is “0”, the resonator 200 may be assumed to have ω_{MZR} as a resonance frequency. The resonance frequency ω_{MZR} may be expressed by Equation 2.

$${ω}_{MZR} = \frac{1}{\sqrt{{L}_{R} {C}_{R}}} \qquad [ Equation 2 ]$$

In Equation 2, MZR denotes a Mμ zero resonator.

Referring to Equation 2, the resonance frequency ω_{MZR} of the resonator 200 may be determined by L_{R}/C_{L}. A physical size of the resonator 200 and the resonance frequency ω_{MZR} may be independent with respect to each other. Because the physical sizes are independent with respect to each other, the physical size of the resonator 200 may be sufficiently reduced.

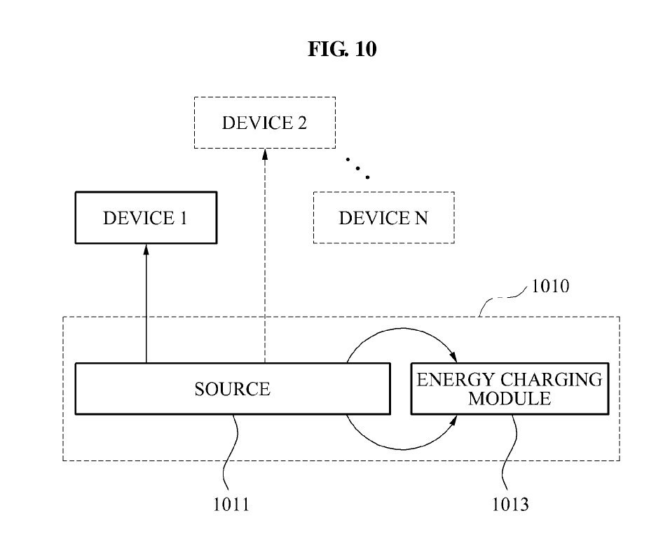

FIG. 10 illustrates a wireless power transmission apparatus. Referring to FIG. 10, wireless power transmission apparatus 1010 includes a source unit 1011, and an energy charging module 1013. The wireless power transmission apparatus 1010 may further include an alternating power generation apparatus (not illustrated), and other additional elements used for wireless power transmission. While the wireless power transmission apparatus 1010 includes the energy charging module 1013 as shown in FIG. 10, it should be understood that the energy charging module 1013 may be separated from the wireless power transmission apparatus 1010. For example, the energy charging module 1013 may wirelessly receive power through magnetic coupling with a source resonator of the source unit 1011, regardless of a location of the energy charging module 1013.

The source unit 1011 may include a source resonator configured to transmit power wirelessly to at least one target device. A relationship between a power input to the source unit 1011, a power lost by radiation, and a power used in target devices may be expressed by Equation 3.

$${P}_{in} = {P}_{Total \_ Rad} + {P}_{Total \_ Ohm} + {\sum }_{1}^{n} {P}_{Work 1 ∼ n} \qquad [ Equation 3 ]$$

In Equation 3, a first term of the right side denotes energy lost by radiation, a second term of the right side denotes a loss caused by a conductor and the like, and a third term of the right side denotes a sum of energy received and consumed by device 1 through device N. When the number of target devices is increased, the total energy transmission efficiency may be increased. Conversely, when the number of target devices is reduced, the total energy transmission efficiency may be reduced. As an example, the power input to the source unit 1011 may be transmitted in proportion to an energy transmission efficiency between the source unit 1011 and target devices.

The energy charging module 1013 may charge power that is obtained by subtracting a power consumed by the at least one target device from the power input to the source unit 1011. For example, when the number of target devices is reduced from N to N−1, the energy charging module 1013 may charge that same amount of power as an amount of power to be consumed by a single target device. Accordingly, the source unit 1011 may control the energy charging module 1013, based on an amount of power consumed by target devices, so that energy may be stored in the energy charging module 1013.

The energy charging module 1013 may retransmit the stored energy to the source unit 1011. Additionally, the energy charging module 1013 may provide the stored energy to another device connected to the energy charging module 1013.

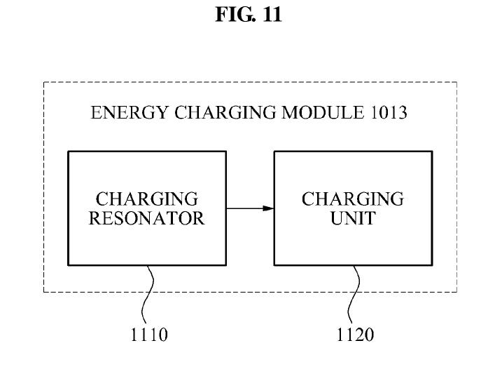

FIG. 11 illustrates an example of an energy charging module shown in FIG. 10.

Referring to FIG. 11, the energy charging module 1013 may include a charging resonator 1110 to receive a power from the source resonator, and a charging unit 1120 to store the power received by the charging resonator 1110. For example, the charging unit 1120 may include a large capacity capacitor.

As described herein, energy that is not transmitted from a source unit to a target device may be stored using an energy charging module, and thus, it is possible to reduce an amount of radiated energy. Additionally, it is possible to reuse an energy that is not transmitted during wireless power transmission, and it is possible to prevent energy from being radiated or consumed as heat, thereby reducing an influence on peripheral apparatuses.

The methods, processes, functions, and software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wireless power transmission apparatus, comprising:
a source unit comprising a source resonator for transmitting power wirelessly to at least one target device; and
an energy charging module for storing energy generated by the source unit under a control of the source unit.

2. The wireless power transmission apparatus of claim 1, wherein the energy charging module charges power that is obtained by subtracting power consumed by the at least one target device from power input to the source unit.

3. The wireless power transmission apparatus of claim 1, wherein the energy charging module retransmits the stored energy to the source unit.

4. The wireless power transmission apparatus of claim 1, wherein the energy charging module provides the stored energy to a device connected to the energy charging module.

5. The wireless power transmission apparatus of claim 1, wherein the energy charging module comprises:
a charging resonator to receive power from the source resonator; and
a large capacity capacitor to store the power received by the charging resonator.

6. An energy charging module for storing energy from a source unit that wirelessly transmits power to one or more target devices, the energy charging module comprising:
a charging resonator to receive power from the source unit; and
a large capacity capacitor to store the power received by the charging resonator,
wherein the energy charging module is controlled by the source unit.

7. The energy charging module of claim 6, wherein the source unit controls the energy charging module to store power received by the source unit but not transmitted by the source unit to the one or more target devices.

8. The energy charging module of claim 6, wherein the charging resonator receives an amount of power from the source unit, and the amount of power is equal to the amount of power input to the source unit minus the amount of power consumed by the one or more target devices.

9. The energy charging module of claim 6, wherein the energy charging module reuses the energy received from the source unit by transmitting the energy back to the source unit.

10. The energy charging module of claim 6, wherein the energy charging module reuses the energy received from the source unit by transmitting the energy to the one or more target devices.

11. The energy charging module of claim 6, wherein the energy charging module is included in the source unit.

12. The energy charging module of claim 6, wherein the energy charging module is not included in the source unit, and the energy charging module receives power from the source unit through magnetic coupling.
